(19) United States
(12) Patent Application Publication
(10) Pub. No.: US 2010/0204874 A1
(43) Pub. Date: Aug. 12, 2010

(54) Universal Motorcycle Cruise Control System

(76) Inventor: Michael William Oyer, Carlisle, MA (US)

Correspondence Address: Michael William Oyer, 124 Stoney Gate, Carlisle, MA, 01741, US

(21) Appl. No.: 12/703,643

(22) Filed: Feb. 10, 2010

Related U.S. Application Data
(60) Provisional application No. 61/152,225, filed on Feb. 12, 2009.

(51) Int. Cl. B60W 30/14; F02D 11/10; G05G 11/00; G06F 7/00

(52) U.S. Cl. 701/29; 123/399; 74/488; 701/93

(57) ABSTRACT

A universal motorcycle cruise control system comprised of three elements: control panel, microprocessor based controller and electromechanical drive assembly. The control panel is mounted to allow the vehicle operator access and allows the operator to command the system and receive visual feedback. The controller monitors commands from the control panel, monitors various dynamic signals from the vehicle and controls the drive assembly to maintain requested speed. The electromechanical drive assembly consists of the following: electric motor, gearbox and electro activated clutch. In a preferred configuration, the electromechanical drive assembly is physically installed inside the handlebar under the operators throttle handgrip and is mechanically connected to the handgrip. When activated, the electromechanical drive assembly causes clockwise and counter clockwise rotation of the handgrip as required maintaining requested vehicle speed. The standard vehicle throttle cables are utilized as the mechanical connection between the handgrip and carburetor or fuel injection system.

### PRIOR ART

References of U.S. Patent Documents cite:

U.S. Pat. No. 6,318,490 B1 Nov. 20, 2001 Laning

U.S. Pat. No. 7,445,071 B2 Nov. 4, 2008 Yamazaki et al.

### FIELD OF THE INVENTION

This invention relates to motorcycles or any vehicle having a rotating throttle pipe handle attached to a handlebar of the vehicle and subsequently attached to one or two cables that themselves attach to a carburetor or fuel injection system for controlling the vehicle speed. Rotation of the throttle pipe handle in one direction causes the vehicle engine to increase RPM's thus causing the vehicle to increase speed. Rotation of the throttle pipe handle in the opposite direction causes the vehicle engine to decrease RPM's thus causing the vehicle to decrease speed. This universal motorcycle cruise control system utilizes an electro-mechanical actuator which mounts within the handlebar beneath the rotating throttle pipe handle, connects to the rotating throttle pipe handle and is controlled by the electronic control module which receives commands from the operator panel.

### BACKGROUND OF THE INVENTION

It is desirous to utilize a cruise control system on motorcycles to reduce rider fatigue. Previous systems utilized on motorcycles suffer from one or more practical problems: They are physically large and weigh too much; they are complex to attach to the vehicle; they are mechanically complex and create a rider safety issue; they hold the throttle in one set position and do not provide dynamic speed control as the vehicle slows or speeds up; they create a rider safety issue requiring the rider to manually deactivate the cruise control system to allow normal manual control of vehicle speed; and they may cause a very serious rider safety issue if a cruise control system component fails and subsequently does not allow the vehicle operator to maintain manual control of the vehicle to both speed up and slow down to avoid a pending crisis.

In U.S. Pat. No. 6,318,490 B1, an electromagnetic clutch is utilized. This electromagnetic clutch is utilized to strictly lock the rotating throttle pipe handle in one position when the cruise system is activated. There is no means in this system to rotate the rotating throttle pipe handle in order to dynamically maintain vehicle speed. In U.S. Pat. No. 7,445,071 B2, an electric motor is used within the mechanical assembly of the handlebar and in close proximity to the rotating throttle pipe handle and coupled to the rotating throttle pipe handle my means of a gear assembly. In this case, the motor is used to cause the rotating throttle pipe handle to rotate to provide feedback to the vehicle operator only. Since this implementation is devoid of flexible control cables going to the carburetor or fuel injection body there is no means for this motor to cause any speed control of the vehicle.

### SUMMARY OF THE INVENTION

The present invention provides true vehicle speed control for any motorcycle utilizing a rotating throttle pipe handle placed over the end of the handlebar and coupled to the engine via standard vehicle factory cables which themselves connect to the vehicle carburetor of fuel injection system.

The universal motorcycle cruise control system in accordance with the present invention consists of three basic components: an electromechanical drive assembly consisting of: an electric motor, a gear reduction module and an electro-activated clutch inserted inside the handlebar beneath the rotating throttle pipe handle and mechanically axially coupled to the rotating throttle pipe handle; an operator panel, mounted within easy reach and view of the vehicle operator, consisting of switches to: activate and deactivate the cruise control, set cruise speed, increase and decrease cruise speed and resume a deactivated set speed and visual lights to indicate the cruise control on and set status to the operator; and an electronic control module which is commanded by the operator panel, monitors the motorcycle speed, engine RPM, vehicle brake status and vehicle clutch status and controls the electromechanical drive assembly to automatically maintain desired motorcycle speed.

An alternate system configuration places one or more of the electromechanical drive assembly components outside the handlebar and couples to the rotating throttle pipe handle via a gear assembly.

By placing the small and light weight electromechanical drive assembly either within the handlebar or close but external to the handlebar and coupling to the rotating throttle pipe handle, several advantages are gained: a physically small, lightweight and esthetic solution is provided; installation is simplified over other solutions because the factory supplied cables connected to the carburetor or fuel injection system are utilized removing the requirement to install additional control cables; vehicle reliability is improved since no new cables are installed; vehicle safety is dramatically improved since manual control of the rotating throttle pipe handle is always allowed in the event of a pending riding crisis or a universal motorcycle cruise control system component or program failure; and a reduced cost solution is provided since a smaller number of system components are required to implement the cruise control function.

The electronic control module constantly monitors the operator panel for operator commands and also monitors the dynamic elements of the vehicle itself providing intelligent operation of the cruise control system. Dynamic control of the cruise control system includes: auto shut-down of speed control when the front or rear break is applied, auto shut-down of speed control if the engine RPM's increase or decrease outside limits or the rate-of-change of the engine RPM's exceeds pre-determined limits; auto shut-down of speed control if the vehicle clutch is disengaged; and provides pre-determined acceleration and deceleration ramps to the electromechanical drive assembly.

### BRIEF DESCRIPTION OF THE FIGURES

FIG. 1 shows the electromechanical drive assembly mounted within the motorcycle handlebar and mechanically connected to the rotating throttle pipe handle by an axial shaft.

FIG. 2 shows the electromechanical drive assembly mounted external to the motorcycle handlebar and mechanically connected to the rotating throttle pipe handle via a gear pair.

FIG. 3 is an internal view of the two control cables connected to the rotating throttle pipe handle.

FIG. 4 is a direct perspective of the two control cable ends which attach to the rotating throttle pipe handle.

FIG. 5 is a block diagram of the electronic control module.

FIG. 6 is a block diagram of the operator panel.

### DETAILED DESCRIPTION OF THE INVENTION

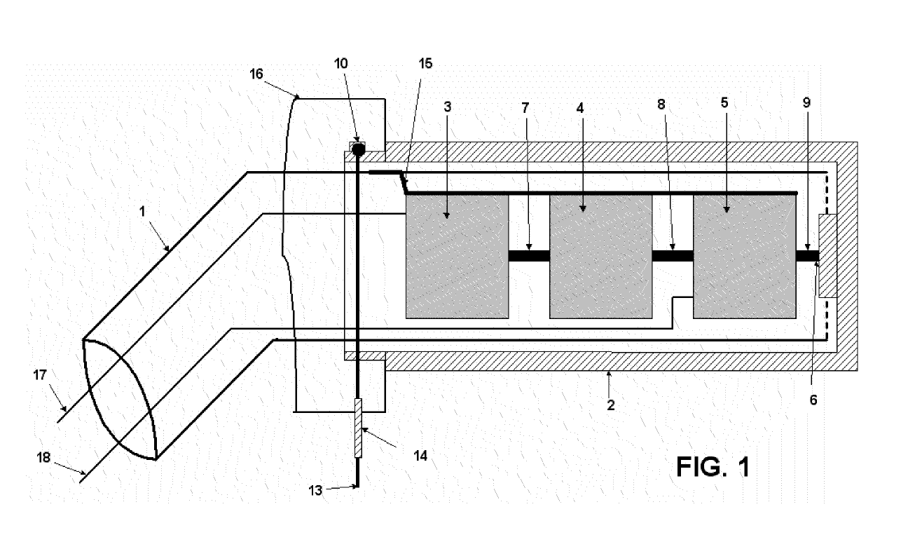

In accordance with the embodiment of the present invention, FIG. 1 illustrates the installation of the electromechanical drive assembly within the vehicle handlebar 1 and consisting of: an electric motor 3, a gear reduction module 4 and an electro-activated clutch 5 inserted inside the handlebar beneath the rotating throttle pipe handle 2. Bracket 15 eliminates movement of the electromechanical drive assembly within the vehicle handlebar 1. The electric motor 3 has an output shaft 7 which is coupled to the gear reduction module 4 input shaft 7. The gear reduction module 4 output shaft is then coupled to the electro-activated clutch 5 input shaft 8. The electro-activated clutch 5 output shaft 9 is then coupled to the rotating throttle pipe handle 2 and mechanically axially coupled to the rotating throttle pipe handle at point 6.

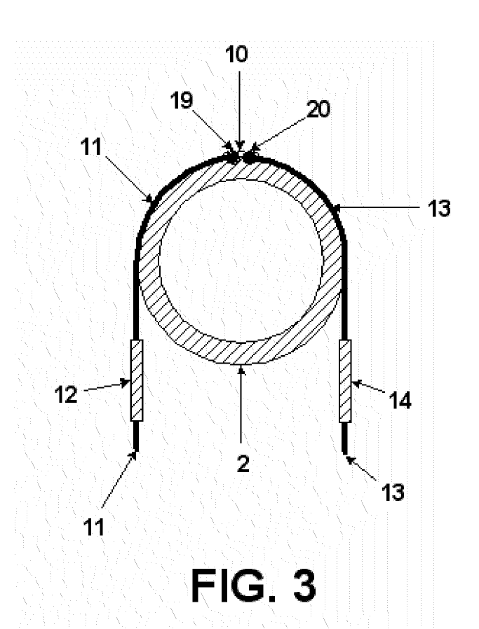

Within the handlebar fixed housing 16, the drive cable assembly's 11 & 12 and 13 & 14, shown in FIG. 3, which connect to the carburetor or fuel injection body, is attached to the rotating throttle pipe handle 2 at location 10.

Electric stimulus to the motor 3 is provided by a wire 17 internal to the handlebar 1. Electric stimulus to the electro-activated clutch 5 is provided by a wire 18 internal to the handlebar 1.

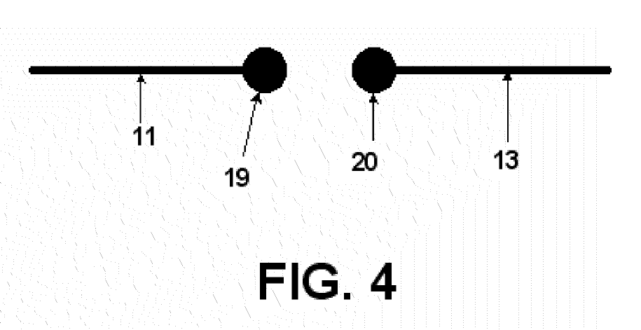

FIG. 4 illustrates the two drive cables 11 & 13 and depicts the ends 19 & 20 which are shown in FIG. 3 wrapped around the rotating throttle pipe handle 2 and connected to the rotating throttle pipe handle 2 at location 10.

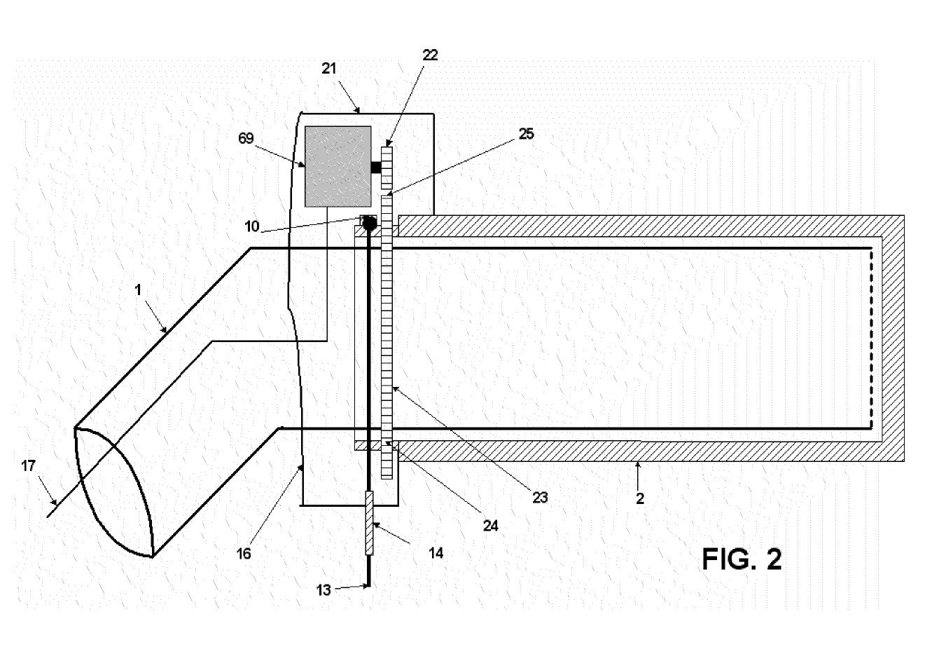

FIG. 2 illustrates the alternate external configuration of the electromechanical drive assembly electric motor 69. In this configuration, the handlebar fixed housing 16 is expanded at location 21 to allow internal mounting of the electric motor 69. The electric motor 69 output gear 22 meshes with the rotating throttle pipe handle 2 attached gear 23 at location 25. The rotating throttle pipe handle gear 23 interlocks with the rotating throttle pipe handle 2 at their interface 24. Electric stimulus to the motor 69 is provided by a wire 17 internal to the handlebar 1.

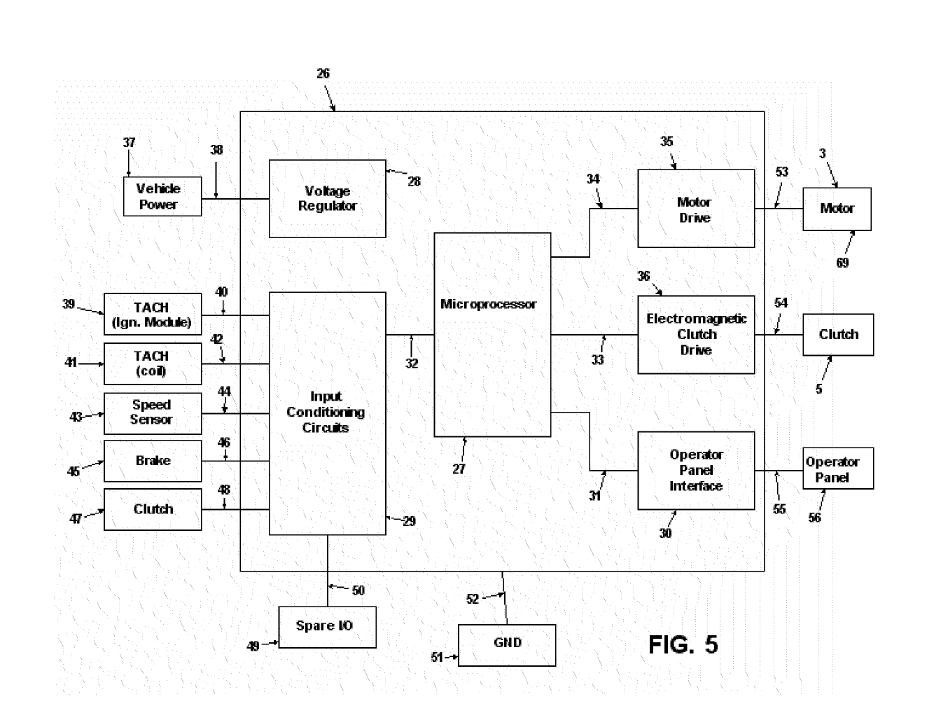

FIG. 5 depicts the electronic control module 26. Functional elements of the electronic control module 26 are: microprocessor 27, a voltage regulator 28, input conditioning circuits 29, a motor drive circuit 35, electromagnetic clutch drive circuit 36, and operator panel interface circuit 30. Interconnection of the circuit elements are provided via the circuit board and are indicated by 31, 32, 33 and 34.

Vehicle power 37 is connected to the electronic control module 26 and is attached to the voltage regulator at 38. The engine RPM signal may originate from one of two vehicle sources: the tachometer drive signal 39 from a vehicle electronic ignition module, and connect to the electronic control module 26, at 40 or the vehicle ignition coil tachometer input 41 connected to the electronic control module 26 at 42.

If the vehicle has a direct digital speed sensor 43, it may be connected to the electronic control module 26 at 44. Vehicle brake active state 45 is connected to the electronic control module 26 at 46. Clutch activation state 47 is connected to the electronic control module 26 at 48.

A signal for controlling the electromechanical drive assembly motor 3 or 69 is provided by the electronic control module 26 at 53. The electromechanical drive assembly electro-activated clutch 5 is provided by the electronic control module 26 at 54. The operator panel 56 interface is provided by the electronic control module 26 at 55. Additional inputs 49 to the electronic control module 26 are provided at 50. Signal and power ground 51 is connected to the electronic control module 26 at 52. The microprocessor 27 is programmed to operate the elements of the speed control system and is easily configured during installation for vehicle specific functionality and operator requested modes of operation.

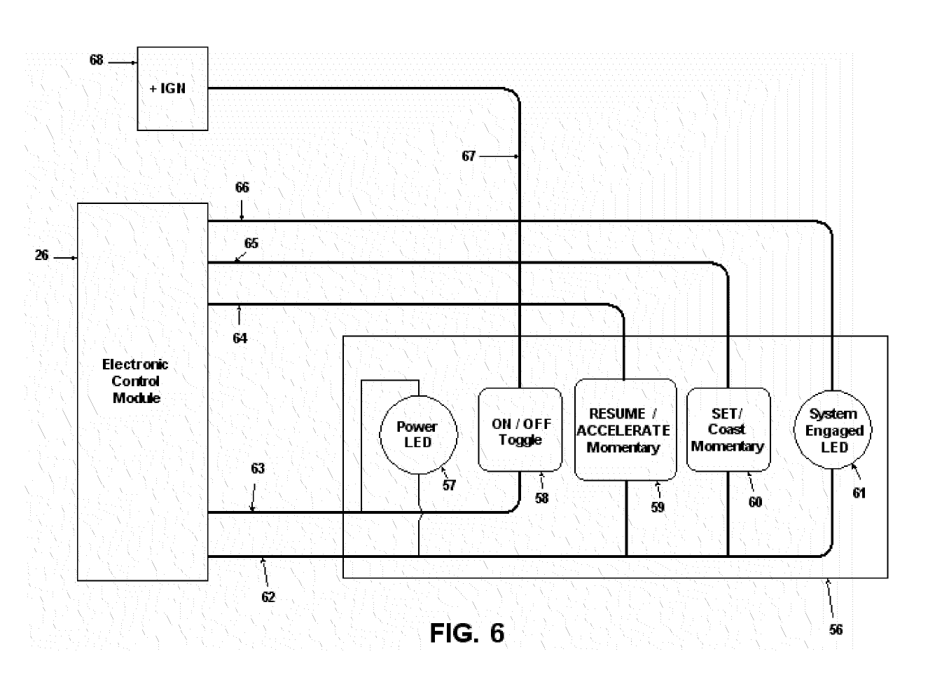

FIG. 6 depicts the operator panel 56 and consists of: system on light emitting diode (LED) 57, on/off switch 58, set/coast switch 60 and system engaged LED 61. When the vehicle ignition switch 68 is turned on, vehicle power is provided to the operator panel 56 at 67. When the on/off switch 58 is turned to the on state, power is provided to the electronic control module 26 at 63 and subsequently turns on the power LED 57. Activation of the system engaged LED 61 is provided by the electronic control module 26 at 66. The resume/accelerate switch 59 is monitored by the electronic control module 26 at 64. The set/coast switch 60 is monitored by the electronic control module 26 at 65.

Under normal motorcycle operation, since the electro-activated clutch 5 is in the non-active state, it's output shaft 9 is decoupled from gear reduction module 4 output shaft 8 thus allowing free and normal manual rotation of the rotating throttle pipe handle 2. In this state, it is as if the universal motorcycle cruise control system is not present. When the vehicle is powered up for use and the universal motorcycle cruise control system is turned on by selecting the on position from switch 58 on the operator panel 56, the universal motorcycle cruise control system may be utilized as an engine speed control device for a programmed period of time. This allows the rotating throttle pipe handle 2 to be held firmly in a position as to cause the vehicle engine to operate at a higher than normal engine idle RPM, thus facilitating a smooth warm up period. Once warm up is complete, the universal motorcycle cruise control system moves to a normal state and is ready for use by the vehicle operator. As the vehicle is ridden, the operator may activate cruse set state by selecting the set position from switch 60 on the operator panel 56. The universal motorcycle cruise control system is now in the control-speed state. The dynamic data of engine RPM and vehicle speed from inputs 39, 41 or 43 connected to the electronic control module 26 allow the electronic control module 26 under programmed control to activate the electro-activated clutch 5 which firmly couples the gear reduction module 4 output shaft 8 to the electro-activated clutch 5 output shaft 9. Since the output shaft 9 is mechanically coupled to the rotating throttle pipe handle 2 at position 6, rotation of the motor 3 causes clockwise or counter clockwise rotation of the rotating throttle pipe handle 2 which in turn causes the vehicle speed to be increased or decreased under control of the electronic control module 26. If dynamic data provided to the electronic control module 26 indicates that the speed of the vehicle has decreased below the set speed, the motor 3 is turned clockwise to force an increase in vehicle speed. If the data provided to the electronic control module 26 indicates that the speed of the vehicle has increased above the set speed, the motor is turned counter clockwise to force a decrease in vehicle speed. This dynamic feedback mechanism continues to maintain set speed of the vehicle until the universal motorcycle cruise control system is turned off or deactivated. In the alternate configuration of FIG. 2, the electric motor 69 is coupled to the rotating throttle pipe handle 2 by gears 22 and 23. Vehicle speed is thus maintained as the activated universal motorcycle cruise control system requires by causing the motor 69 to rotate which in turn, causes the rotating throttle pipe handle 2 to turn allowing vehicle speed control as previously discussed. In this configuration, no gear reduction module 4 is required since the gear 22 & 23 ratio provides the necessary torque amplification.

Several mechanisms may shut down the system and allow normal operation of the motorcycle throttle universal motorcycle cruise control system: activation of switch 58 on the operator panel 56, application of brake signal 45, activation of clutch signal 47, deactivation of vehicle power 37, a spare I/O signal 49 attached at 50 to electronic control module 26, or the or the electronic control module 26 may determine that the rate-of-change of engine RPM's has risen beyond a programmed limit. Once deactivated, the maintained set speed point may be resumed by switch 59. Once resumed, the set speed may be increased by switch 59 or decreased by switch 60.

An important safety feature of the universal motorcycle cruise control system is provided by the electro-activated clutch 5. When this clutch is activated allowing the motor 3 to turn the rotating throttle pipe handle 2, manual operator control is always possible. The electro-activated clutch 5 will slip allowing manual control of the rotating throttle pipe handle 2 to speed up or slow down the vehicle when the vehicle operator turns the rotating throttle pipe handle 2 with sufficient torque beyond the electro-activated clutch 5 normal holding specification. This safety feature prevents any universal motorcycle cruise control system failure from stopping the vehicle operator from manually controlling vehicle speed as if the universal motorcycle cruise control system were not present. In the alternate configuration of FIG. 2, the operator may turn the rotating throttle pipe handle 2 with sufficient torque as to override the holding force of the electric motor 69 and again, allows the vehicle operator manual control of the vehicle speed.

I claim:

1. An automatic universal motorcycle cruise control system mounted to a handlebar comprising a rotating throttle pipe handle, an electromechanical drive assembly, and an electronic measurement and processing system; wherein said rotating throttle pipe handle is placed over the end of the handlebar and coupled to the engine throttle; wherein said electromechanical drive assembly further comprises an electric motor, a gear reduction module and an electro activated clutch; wherein said electromechanical drive assembly is inserted inside said handlebar beneath said rotating throttle pipe handle; wherein said electromechanical drive assembly is mechanically axially coupled to said rotating throttle pipe handle; whereby the act of rotation of said throttle pipe handle selected from a group consisting of manual rotation and electromechanical rotation by said electromechanical drive assembly adjusts the speed of the engine.

2. The automatic universal motorcycle cruise control system according to claim 1, wherein said electromechanical drive assembly when in the activated state allowing automatic vehicle speed control by causing said throttle pipe handle to automatically rotate clockwise and or counter clockwise in response to stimulus of said electronic measurement and processing system.

3. The automatic universal motorcycle cruise control system according to claim 1 further comprising: an operator panel comprising manual control selected from a group consisting of activate cruise control, deactivate the cruise control, set cruise speed, increase, cruise speed, decrease cruise speed, resume, resume a deactivated set speed; whereby said operator panel is mounted within easy reach and view of the vehicle operator.

4. The automatic universal motorcycle cruise control system according to claim 3 wherein said operator panel further comprises visual lights to indicate status from a group consisting of status and control state.

5. The automatic universal motorcycle cruise control system according to claim 1 wherein said electronic measurement and control system measures data from a group consisting of commands from said operator panel, motorcycle speed, engine rpm, vehicle brake status and vehicle clutch.

6. The automatic universal motorcycle cruise control system according to claim 5 wherein said electronic measurement and control system processes said measured data to automatically maintain desired motorcycle speed by activating said electromechanical drive assembly.

7. The automatic universal motorcycle cruise control system according to claim 1, wherein said clutch of said electromechanical drive assembly allows manual override of said electromechanical assembly by turning said rotating throttle pipe handle with enough torque as to slip said electro activated clutch; whereby manual override of said electromechanical drive assembly is available while in activated mode.

8. The automatic universal motorcycle cruise control system according to claim 1, wherein said electromechanical drive assembly is mounted external to the handlebar; wherein said electromechanical drive assembly is mechanically connected to said rotating throttle pipe handle by a gear connection.

9. The automatic universal motorcycle cruise control system according to claim 8, wherein said electromechanical drive assembly is reduced to a motor.

10. The automatic universal motorcycle cruise control system according to claim 1, wherein said motor of said electromechanical drive assembly is selected from a group consisting of dc brush type, dc brushless type, stepper type, reluctance type, permanent magnet type, single phase AC type, and multiple phase AC type.
